(19) United States
(12) Patent Application Publication
(10) Pub. No.: US 2007/0137354 A1
(43) Pub. Date: Jun. 21, 2007

(54) BRAKE GOVERNOR OF A VEHICLE

(75) Inventors: Andrej Andrejevich Botalenko, Minsk (BY); Ivan Aleksandrovich Bolatau, Minsk (BY); Vasili Ivanovich Halias, Minsk (BY)

Correspondence Address: HOUSTON ELISEEVA, 4 MILITIA DRIVE, SUITE 4, LEXINGTON, MA, 02421, US

(73) Assignee: Obshchestvo s Dopolnitelnoj Otvetstvennostju "DISKOMS", Minsk (BY)

(21) Appl. No.: 11/559,453

(22) Filed: Nov. 14, 2006

(30) Foreign Application Priority Data
Nov. 14, 2005 (BY) A20051094

(51) Int. Cl. F16H 1/16; F16H 1/20

(52) U.S. Cl. 74/425

(57) ABSTRACT

The invention relates to mechanical engineering, notably to brake governors, and can be used in air-operated and cam-operated brake arrangements of vehicles. The brake governor of the vehicle contains a housing used as a lever, which contains a worm gearing consisting of a worm-wheel and a worm screw, a screw gearing consisting of a helical screw and a tooth gear wheel which is arranged coaxially to the worm screw of the worm gearing, which is kinematically connected with it and is limited in its axial movement, and a toothed gearing, the drive pinion of which is arranged coaxially to the worm-wheel of the worm gearing, and the driven gear is arranged coaxially to the helical screw of the screw gearing and is connected with it by means of the drive train comprising a spring-mounted half-coupling with a cam crown at the flank turned to the flank of the helical screw of the screw gearing, which is fixed with the possibility of axial movement relative to the driven gear of the toothed gearing. The brake governor differs from the known ones in that between the said half-coupling and the helical screw of the screw gearing, in the axial alignment to them there is a second spring-mounted half-coupling fixed, at the flank of which there is an identical cam crown made, turned to the flank of the first half-coupling and at the opposite flank and at the flank of the helical screw of the screw gear turned to it there are also identical cam crowns made, at that both half-couplings are spring-mounted with compression springs.

### RELATED APPLICATIONS

This application claims priority to the application serial number a2005 1094 of the Republic of Belarus, filed on Nov. 14, 2005, which is incorporated herein by reference in its entirety.

### FIELD OF THE INVENTION

The invention relates to mechanical engineering, namely to brake governors, and can be used in air-operated and cam-operated brake arrangements of vehicles.

### BACKGROUND OF THE INVENTION

The brake governor currently in use contains a housing which is used as a lever with a worm gearing consisting of a worm wheel and a worm screw, a screw gearing, the tooth gear wheel of which is arranged coaxially to the worm screw, and is kinematically connected with it by means of a clutch and is limited in its axial movement, and a toothed gearing, the drive pinion of which is arranged coaxially to the worm wheel, while the driven gear is arranged coaxially to the helical screw of the screw gearing and is kinematically connected with it by means of a freewheel clutch [1].

The given brake governor is of complex design. It contains a lot of difficult-to-make component parts which results in high labor content of its manufacturing.

A brake governor of the vehicle currently in use contains a housing used as a lever and a worm gearing located in its cavities consisting of a worm wheel and a worm screw; a screw gearing, the tooth gear wheel of which is arranged coaxially to the worm screw of the worm gearing and is kinematically connected with it by means of a clutch and is limited in its axial movement; a toothed gearing, the drive pinion of which is arranged coaxially to the worm wheel of the worm gearing, and the driven gear is arranged coaxially to the helical screw of the screw gearing and is kinematically connected with it by means of a freewheel clutch, which is formed by a half-coupling with a cam crown at the flank turned to the flank of the helical screw and the corresponding cam crown on the mentioned flank of the helical screw, as well as a torsion spring for holding on the cam coupling in closed condition [2].

The disadvantage of the governor currently in use is that the drive pinion of the toothed gearing and a freewheel half-coupling are spring-mounted to each other with a spring which at the same time is a torsion spring and a compression spring. Thus, the connection of the driven gear and the half-coupling, providing rotation transmission and mutual axial movement, is always loaded with the torsion torque of the spring. As a result, the axial movement of the half-coupling is hampered, making the working process of the freewheel clutch unreliable. It means that the process of brake modulation is unreliable, too. Besides, this technical decision demands mandatory application of a difficult-to-make release clutch for connection of the tooth gear wheel of the screw gearing with the warm screw.

### SUMMARY OF THE INVENTION

The engineering problem of the present invention lies in elimination of the specified drawbacks, i.e. reliability improvement of the process of brake modulation and design simplification.

The aforementioned problem can be solved by a brake governor of the vehicle, which contains a housing used as a lever and a worm gearing located in its cavities which includes a worm wheel and a worm screw, a screw gearing consisting of a helical screw and a tooth gear wheel which is arranged coaxially to the worm screw of the worm gearing, is kinematically connected with it and is limited in its axial movement; and a toothed gearing, the drive pinion of which is arranged coaxially to the worm wheel of the worm gearing, and the driven gear is arranged coaxially to the helical screw of the screw gearing and is connected with it by means of the drive train comprising a spring-mounted half-coupling with a cam crown at its flank turned to the flank of the helical screw of the screw gearing, which is fixed with the possibility of axial movement relative to the driven gear of the toothed gearing; between the forementioned half-coupling and the helical screw of the screw gearing a second spring-mounted half-coupling is mounted coaxially to them, at the flank of which, turned to the flank of the first half-coupling, there is an identical cam crown, and at the opposite flank and at the flank of the helical screw of the screw gearing turned to it there are also identical cam crowns, both half-couplings being spring-mounted with compression springs.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows is a brake governor with a local cutaway view endwise the worm screw of the worm gearing; FIG. 2 shows the governor in section I-I; FIG. 3 shows the governor section endwise the helical screw of the screw gearing; FIG. 4 shows component parts of the brake governor in axonometry.

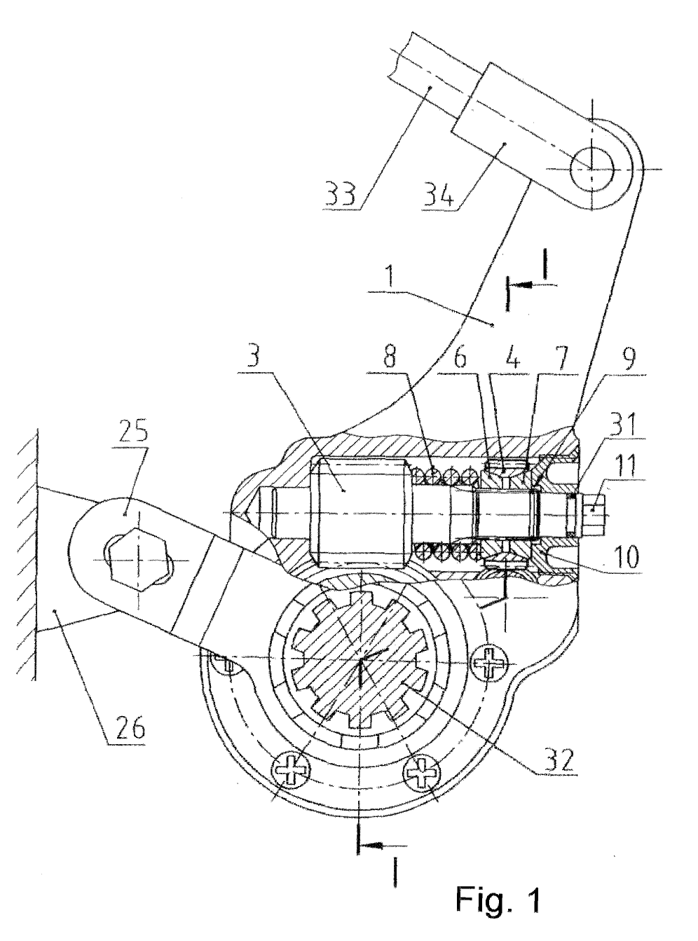

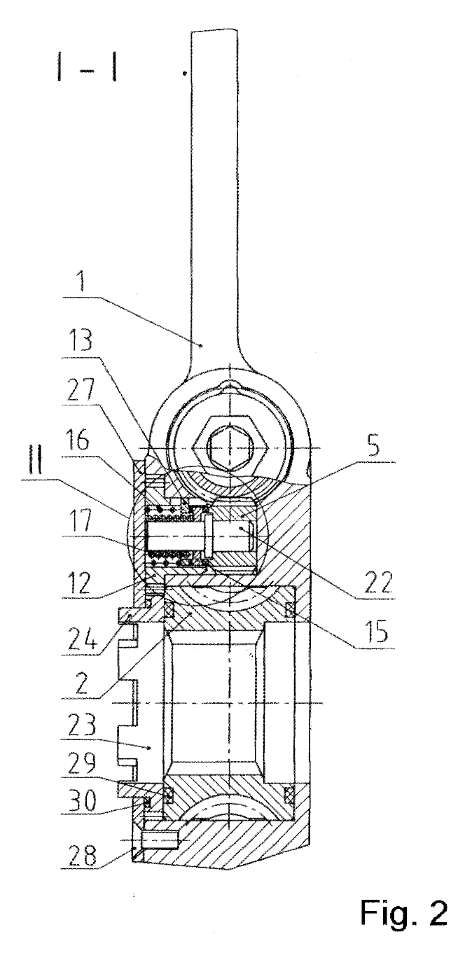

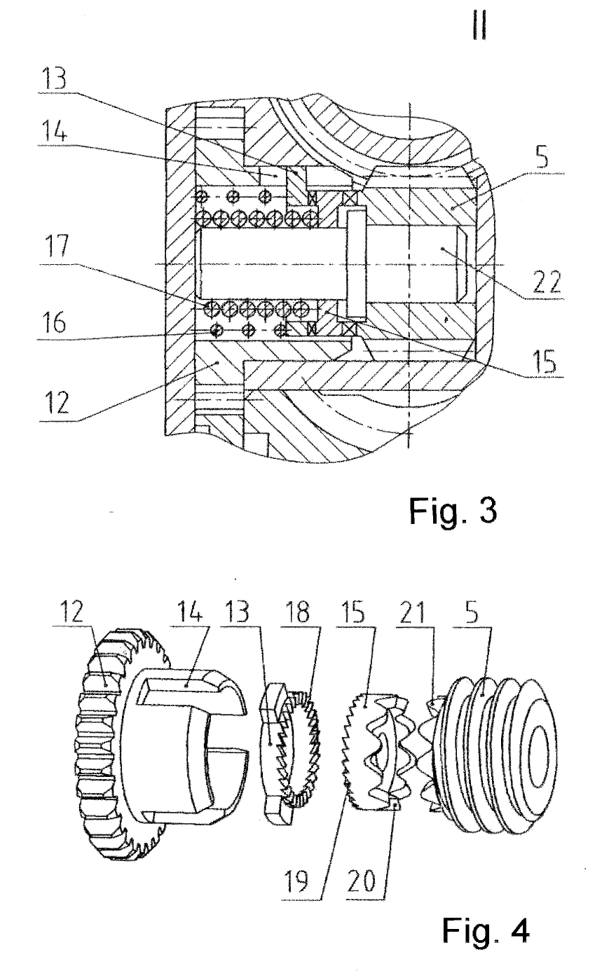

### DETAILED DESCRIPTION OF THE PREFERRED EMBODIMENTS

The vehicle brake governor contains a housing 1 which performs the function of the brake lever. Inside the housing 1 in the corresponding cavities there are a worm gearing which includes a worm wheel 2 and a worm screw 3, and a screw gearing which includes a tooth gear wheel 4 which is arranged coaxially to the worm screw 3, and a helical screw 5. The tooth gear wheel 4 is kinematically connected with the worm screw 3 by means of a frictional overtime clutch, which includes conical frictional elements 6 and 7, kept in the compressed condition by the spring 8 and connected by means of profile connections with the worm screw 3. The circlip 9 fixes in the axial direction the frictional clutch together with the tooth gear wheel 4 of the screw gearing. The worm screw 3 together with the frictional clutch is fixed from the axial movement by means of the thread bushing 10 which is at the same time a blind plug in the housing 1.

The worm screw 3 has a contour shank 11 jutting out of the housing for interaction with the hand-held rotary tool. It is expedient to make a cross-section of the shank 11 a standard one, for example, in the form of a hexagonal shank. Then it is possible to use a standard wrench as a rotary tool.

The housing 1 comprises a toothed gearing, the driven gear 12 of which is connected with the aforementioned helical screw 5 by means of a drive train which includes the first half-coupling 13, the radial cams of which are meshed with the clutch slots 14 of the driven gear 12 with the ability of axial movement, and the second half-coupling 15. Both half-couplings are arranged coaxially to the helical screw 5 of the screw gearing and are spring-mounted with compression springs 16 and 17 accordingly.

At that, at the flank of the first half-coupling 13 and at the flank of the second half-coupling 15, which is turned to it, there are identical cam crowns 18 and 19 accordingly, which form at meshing a freewheel clutch, and at the other flank of the second half-coupling 15 and the flank of the screw 5, which is turned to it, are identical cam crowns 20 and 21 accordingly, forming at meshing an overtime clutch.

To fix the helical screw 5 of the screw gearing from the axial movement a thrust block 22 is provided.

In axial alignment to the worm wheel 2 there is the drive pinion 23 of the toothed gearing which is meshed with the driven gear 12 and is supplied with frontal tangs 24 with the lever 25, the end of which is connected to the stationary part 26. The corresponding cavity of the housing 1 is closed with the cover 27 fixed on the housing 1 with the helical screws 28. The filler rings 29, 30 and 31 pressurise the inner cavity of the governor.

In the vehicle the governor is mounted on the shaft 32 of the brake driving actuator and is connected with the guide bar 33 of the brake chamber (not specified) by means of the fork 34.

The governor works in the following way.

In the process of braking the guide bar 33 effects the governor housing 1 through the fork 34 and turns the housing in the clockwise direction. The drive pinion 23 of the toothed gearing, connected by means of the lever 25 with the stationary part 26, remains non-rotatable. The driven gear 12 of the toothed gearing, revolving on around the drive pinion 23, is pivoting relative to the housing 1. Further the rotation is transmitted to the second half-coupling 13. As a result of the rotation of the half-coupling 13 the first Curvic coupling (cam crowns 18 and 19), which was in the starting position in the open condition, starts to interlock. If the brake is adjusted correctly the complete interlocking of the Curvic coupling and readiness of the freewheel clutch to transmit torsion torque occur simultaneously with a full taking up backlash of the brake slack, i.e. at the moment of the brake pads pressing to the brake drum.

At the further turn of the housing 1 under the elastic deformation of component parts of the brake driving actuator, the driven gear 12 of the toothed gearing keeps on turning together with the first 13 and the second 15 half-couplings. However, the rotation is not transmitted further, as the torsion torque transmitted by the overtime clutch, is not sufficient for rotation of component parts of the screw and worm gearings on-loading and the first cam coupling (cam crowns 20 and 21) is unlocked.

At brake releasing all component parts of the governor reset. In this case brake regulation does not occur. If the brake slack does not exceed the set value, the cam coupling of the freewheel clutch in the starting position is unlocked, i.e. the cam tops of the crown 18 seat on the cam tops of the crown 19.

Because of the brake-shoe lining wear the brake slack increases. Then, during the brake releasing before pressing the brake pads to the brake drum, the housing 1 turns at a greater angle and locking of connection in the overtime clutch happens earlier than pressing the brake pads to the brake drum. At turn of the housing 1 after locking of the connection in the freewheel clutch before pressing the brake pads to the brake drum it turns at the corresponding angle to the reduction of the brake slack and the helical screw 5, i.e. a regulation of the brake slack occurs.

Since the helical screw 5 turns at a certain angle cams of the crown 18 of the freewheel clutch omit one step relative to the cams of the crown 19 during the releasing of brake at component parts of the governor returning to the starting position, and in the starting position connection of cams in the freewheel clutch is locked. Therefore during the next braking before the moment of the brake pads pressing to the drum the helical screw 5 turns at the angle corresponding to one clutch of the connection of the freewheel clutch, i.e. again a brake regulation occurs. The process of regulation repeats at each braking cycle until the slack will not be decreased up to the required value.

When replacing brake-shoe linings at the brake disassembling, there is a necessity for manual adjustment of the slack. For this purpose it is necessary to put a rotary tool (for example, a wrench) on the contour shank 11 of the worm screw 3, and, by applying a rotary force, turn the worm screw 3 in the required direction. The manual rotation of the worm screw 3 is possible due to the frictional clutch which in this case slips. At the rotation of the worm screw 3 clockwise, the brake slack decreases, and at rotation in the opposite direction—increases. Thus manual regulation of the brake is carried out.

The design of the governor is simple. It contains few component parts and provides a reliable process of brake regulation.

While this invention has been particularly shown and described with references to preferred embodiments thereof, it will be understood by those skilled in the art that various changes in form and details may be made therein without departing from the scope of the invention encompassed by the appended claims.

What is claimed is:

1. The brake governor of the vehicle, containing a casing used as a lever, which contains a worm gearing including a worm-wheel and a worm screw, a screw gearing consisting of a helical screw and a tooth gear wheel which is arranged coaxially to the worm screw of the worm gear, which is kinematically connected with it and is limited in its axial movement, and a toothed gearing, the drive pinion of which is arranged coaxially to the worm-wheel of the worm gearing, and the driven gear which is arranged coaxially to the helical screw of the screw gearing and is connected with it by means of the drive train comprising a spring-mounted half-coupling with a cam crown at the flank turned to the flank of the helical screw of the screw gearing, which is fixed with the possibility of the axial movement relative to the driven gear of the toothed gearing, characterized in that between the said half-coupling and the helical screw of the screw gearing, coaxially to them there is a second spring-mounted half-coupling mounted, at the flank of which, turned to the flank of the first half-coupling, there is an identical cam crown, and at the opposite flank and at the flank of the helical screw of the screw gearing turned to it there are also identical cam crowns, at that both half-couplings are spring-mounted with compression springs.
